(19) United States
(12) Patent Application Publication
(10) Pub. No.: US 2014/0041962 A1
(43) Pub. Date: Feb. 13, 2014

(54) SELF-MOVING OPERATING MACHINE WITH VARIABLE AXLE WIDTH

(71) Applicant: Giovanni Borghi, Modena (IT)

(72) Inventor: Giovanni Borghi, Modena (IT)

(73) Assignee: C.M.C. S.R.L. - SOCIETA UNIPERSONALE, Castelfranco Emilia (Modena) (IT)

(21) Appl. No.: 14/001,847

(22) PCT Filed: Jan. 13, 2012
(86) PCT No.: PCT/IB2012/000041

§ 371 Date: Oct. 30, 2013

(30) Foreign Application Priority Data
Mar. 3, 2011 (IT) MO2011A000048

(51) Int. Cl. B60B 35/10; B66F 11/04

(52) U.S. Cl. CPC B60B 35/1036; B66F 11/046
USPC 182/63.1; 180/209

(57) ABSTRACT

A self-moving operating machine with an axle having variable wheel gap, includes a chassis (1) to which a first axle (2) and a second axle (3) are bound respectively, and by which an operating arm (4) is supported, which is hinged with its base to the chassis (1) and carries a tool (5) at its free end. The first axle (2) and the second axle (3) are parallel to each other and provided with a pair of wheels (12) and with a pair of wheels (13) respectively. The first axle (2) has a length that varies upon command and includes at least two half-axles (2a, 2b) which are co-aligned and coupled to each other in axially sliding way. At least one of the half-axles (2a, 2b) is coupled in axially sliding way in a seat (10) made in a body (11) integral with the chassis (1) along a direction parallel to that of relative axial sliding between the two half-axles (2a, 2b). An actuator (6) is provided for acting, upon command, between said body (11) and that of said two half-axles (2a, 2b) which is not coupled to the seat (10), in a direction parallel to that of relative axial sliding between the two half-axles (2a, 2b).

The invention relates to the technical field of the self-propelled operating machines.

Said machines include those which are provided by integrated construction of a vehicle, which is suitably studied to support an equipment like, for example, a lifting mechanism with inclinable and/or articulated telescopic arm, whose one end carries a tool, with which loads are lifted and transported.

Problems related to possible overturning and the possibility to carry out not significant lateral movements without the necessity to reposition the machine, are particularly important for these machines.

In a non exclusive way, these problems are particularly evident for some applications, which include their use, for example, in operations carried out for agricultural activities, where it is required to reach fairly high levels, as well as to carry out lateral movements maintaining the level position.

This occurs, for example, with harvesting some kinds of fruits, as a pure example, dates.

Self-propelled machines are known which, however, in order to allow safe operation of the operating device or arm, are provided with stabilizer feet, even only at front side, suitably aimed, on command, at lifting the corresponding wheels from the ground, when, with the vehicle being stationary, the machine is being prepared for working.

It is clear that, when the machine is positioned, with the stabilizer feet being operated, even only the front ones, set up, the operating member, which is often constituted by a telescopic or articulated arm, hinged to the machine chassis about a fixed gudgeon and carrying, at its end the tool, for example an aerial work platform, is no longer allowed to carry out certain movements. In particular, it is not allowed to perform lateral movements, even of small entity, in order to take the correct position for continuation of the operations to carry out.

This causes a limit in operation which, in this case, can be overcome only after having relocated or repositioned the machine, thus requiring time, which, for the purposes of carrying out the operation for which the machine is used (for example, harvesting particular fruit), is to be considered wasted, for all practical purposes.

Such a limit in operation can be of course overcome by more expensive machines, having better performance, which have a greater degree of freedom, having the telescopic or articulated arm mounted on a platform that rotates about a vertical axis. This allows, for example, rotation of the telescopic arm on command, allowing it to move laterally without the necessity to position the whole machine. Obviously, such solutions are somewhat complicated from the constructive point of view, and consequently, their costs are proportioned and in many cases not justified by the types of operations to carry out.

An object of the present invention is to overcome the prior art limits by means of a self-moving operating machine, characterized by a very simple structure, which is able to allow lateral movements keeping the tool height position without the necessity to reposition the machine.

Another important object of the present invention is to satisfy the mandatory safety conditions required for such applications, without the help of stabilizer feet, which must be positioned on the ground and consequently, need movements and related time for each positioning.

In addition, being self-moving, the machine must have all the characteristics and requirements necessary to travel on the road.

Said achieved objects and advantages are obtained by the invention as illustrated in the present description and defined in the claims.

In particular, an advantageous characteristic of the invention derives from the fact that it achieves the indicated objects using an extremely simple structure.

The characteristics of the invention will become evident from the following description of a preferred embodiment, illustrated by way of a not limiting example in the enclosed Figures, in which:

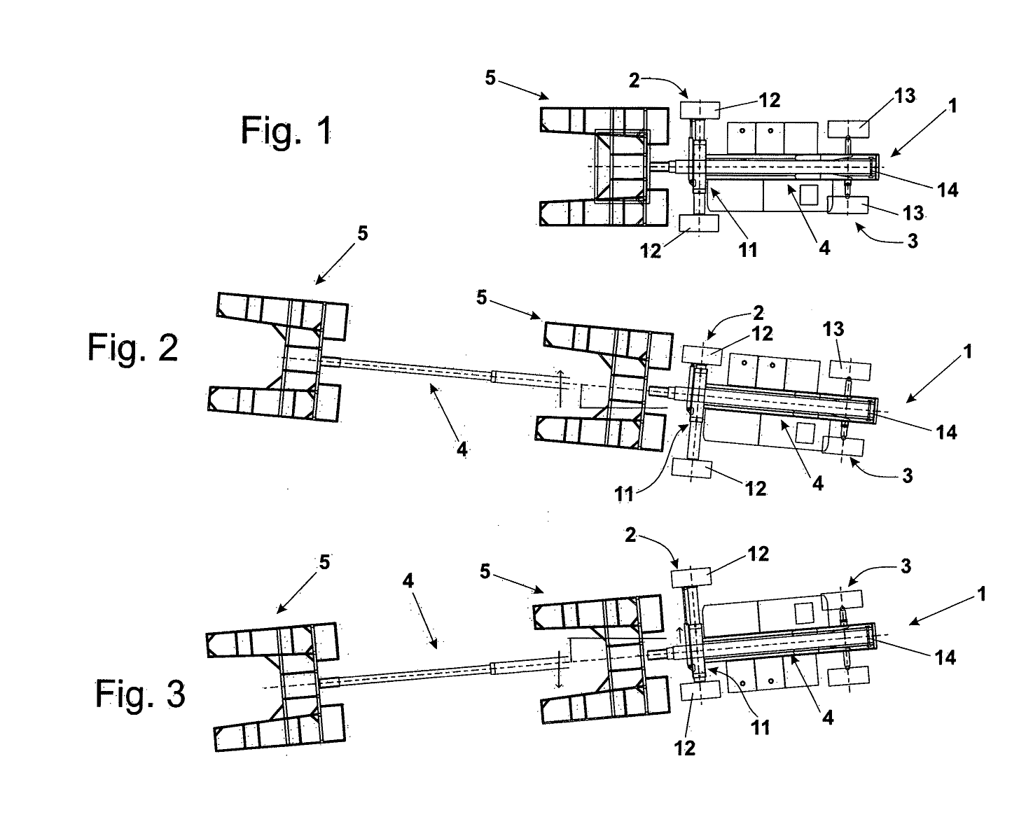

FIG. 1 is a plan view thereof from above;

FIG. 2 is the same plan view from above of FIG. 1 with regard to a different in-operation configuration;

FIG. 3 is the same plan view from above of FIG. 2 with regard to a further different in-operation configuration;

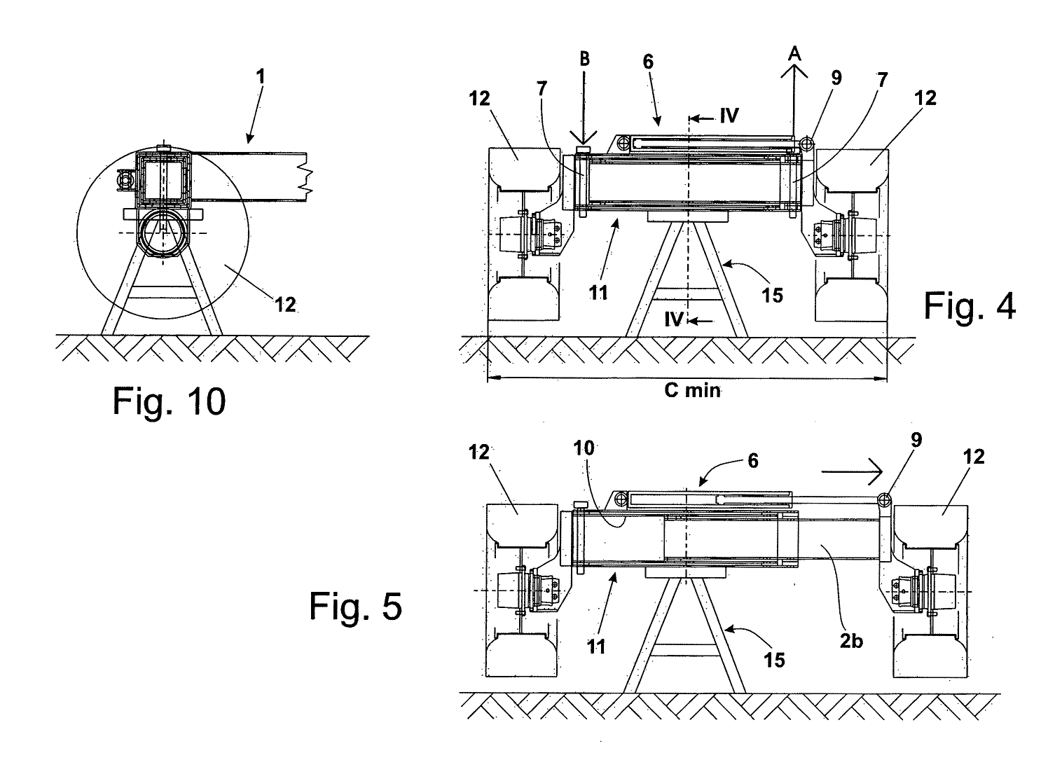

FIGS. 4, 5, 6, 7, 8 are axial cross-sectional views taken along a vertical plane of as many in-operation configurations of the axle 2 of the invention;

FIG. 10 shows a part of a schematic section taken along the tracing line IV-IV of FIG. 4.

With reference to the mentioned Figures, the reference numeral 1 indicates, as a whole, the chassis of a self-moving operating machine which presents the peculiarity of having an axle that can be defined as having a variable wheel gap.

Actually, this machine has a first axle 2 and a second axle 3, which are bound respectively to the chassis 1 and are parallel to each other, and are provided with pairs of wheels respectively 12 and 13.

The chassis 1 supports also an operating arm 4, which is hinged, at its base, to the chassis 1 by means of a gudgeon 14 and supports, suitably bound to its free end, a tool, in this case constituted by an aerial work platform 5.

There are also means for driving and steering the vehicle, as well as means for motion and control of the movements of the operating arm 4 and of the relative tool or aerial work platform 5. In particular, the operating machine is provided with a hydraulic control unit, whose task is to supply various hydraulic actuators, with which it is equipped.

In the shown embodiment, the first axle 2 has a length that varies upon command (which allows to vary the wheel gap) and includes at least two half-axles 2a and 2b, which are co-aligned and coupled to each other in axially sliding way.

At least one of said half-axles 2a, 2b is coupled in axially sliding way in a seat 10, made in a body 11 integral with the chassis 1, along a direction parallel to that of relative axial sliding between the two half-axles 2a and 2b.

The relative motion is provided by an actuator 6, which operates, upon command, between the body 11 and that of the said two half-axles 2a and 2b which is not coupled in the seat 10 in a direction parallel to that of the relative axial sliding of said two half-axles 2a and 2b.

The latter have a tubular shape, have substantially the same length and are proportioned so that the half-axle 2b which, in the shown embodiment, is not coupled directly to the seat 10, can be coupled inside the half-axle 2a, which, on the contrary, is coupled in axial sliding way in the seat 10.

The actuator 6 is a linear actuator, which is constituted in this case by a double-acting type hydraulic cylinder, and which has the bottom side bound to the body 11 and the end of the stem bound to a connection point 9, provided integral to the half-axle 2b, which is not coupled in the seat 10.

In particular, the actuator 6 is bound and situated outside said body 11 with the axis parallel to those of the seat 10.

The half-axles 2a and 2b of tubular shape have a polygonal cross section, in this case square. They are sliding axially one with respect to the other and thus they can be placed in various axial position one with respect to the other.

Their relative position, as well as their position with respect to the body 11 and to the corresponding seat 10, can be indeed fixed in prefixed way by means of locking, which can be carried out simply by first and second stops 7 and 8.

These first and second stops 7 and 8 are removable manually and are constituted substantially by pins prepared to be housed perfectly in holes or recesses made in the half-axles 2a and 2b, as well as in the body 11.

In particular, the first stops 7 are constituted by gudgeons which are proportioned so as to be housed in holes or recesses made in said body 11 and in the half-axles 2a and 2b and to interact, once placed in position, between the body 11 and the half-axles.

The second stops 8 are formed by gudgeons, which are proportioned so as to be housed in holes or recesses provided in the half-axles 2a and 2b and to act therebetween.

The said holes or recesses have axes, which are transversal with respect to the axes of the body 11, of the relative seat 10 and of the half-axles 2a and 2b.

The operating machine, in the configuration shown in FIG. 4, which is the one suitable for on road travelling, has the minimum width Cmin of the fore wheel gap that corresponds to the minimum extension of the fore axle 2. Once the operation site has been reached, it is possible to widen the fore wheel gap, producing the extension of the axle 2 in the way described below.

In order to allow an easy carrying out of the widening operation, the axle 2 is lifted from the ground and kept in the lifted position by means of a support 15. In these condition, the operations indicated schematically in the Figures from 4 to 9 can be carried out one after another.

In particular, FIG. 4 shows schematically the operation, during which the stop or gudgeon 7 is removed from position A, while the analogous stop or gudgeon 7 remains in position B.

FIG. 5 shows the operation in which the half-axle 2b is extended by the actuator 6, which is nothing but a hydraulic cylinder that is proportioned and bound to the body 11 so as to carry out (at least) the desired extension of the half-axle 2b (for example, of 0.5 m).

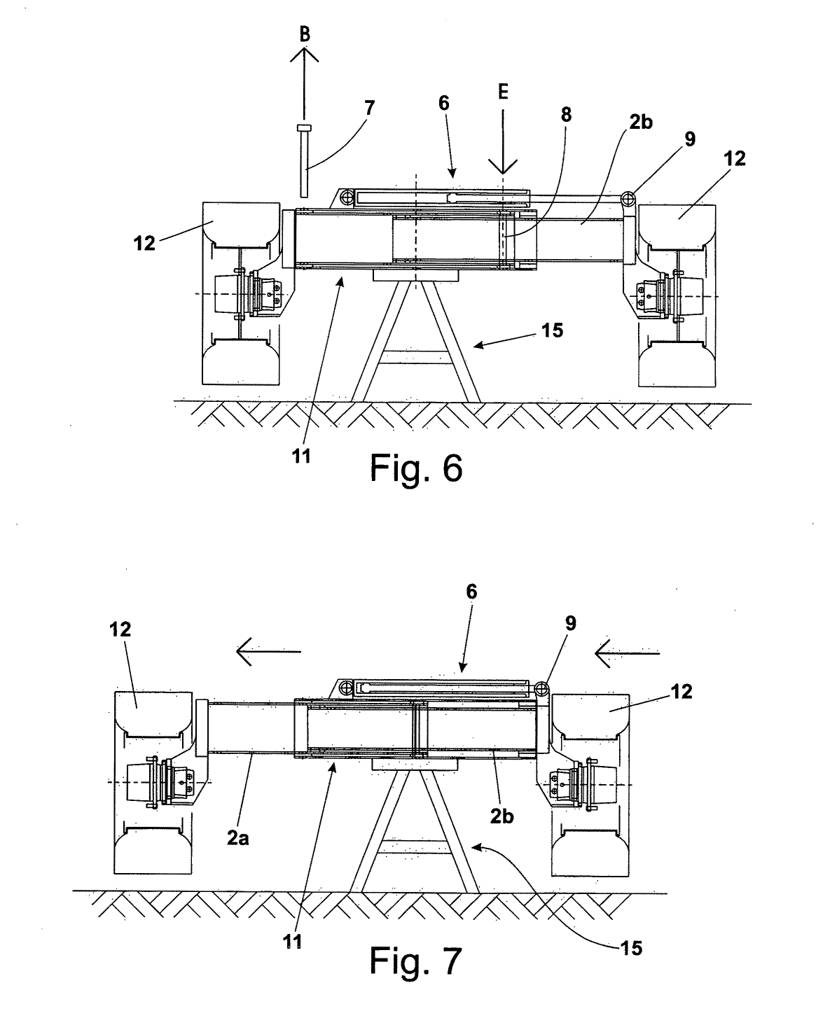

FIG. 6 shows the introduction of a stop or gudgeon 8 in position E and the removal of the stop or gudgeon 7 from position B the removal of the stop or gudgeon 7 from position B.

FIG. 7 shows the return of the withdrawal of the actuator or hydraulic cylinder 6. Due to the locking between the two half-axles 2a and 2b, the whole body 11 slides axially with respect to the half-axle 2a.

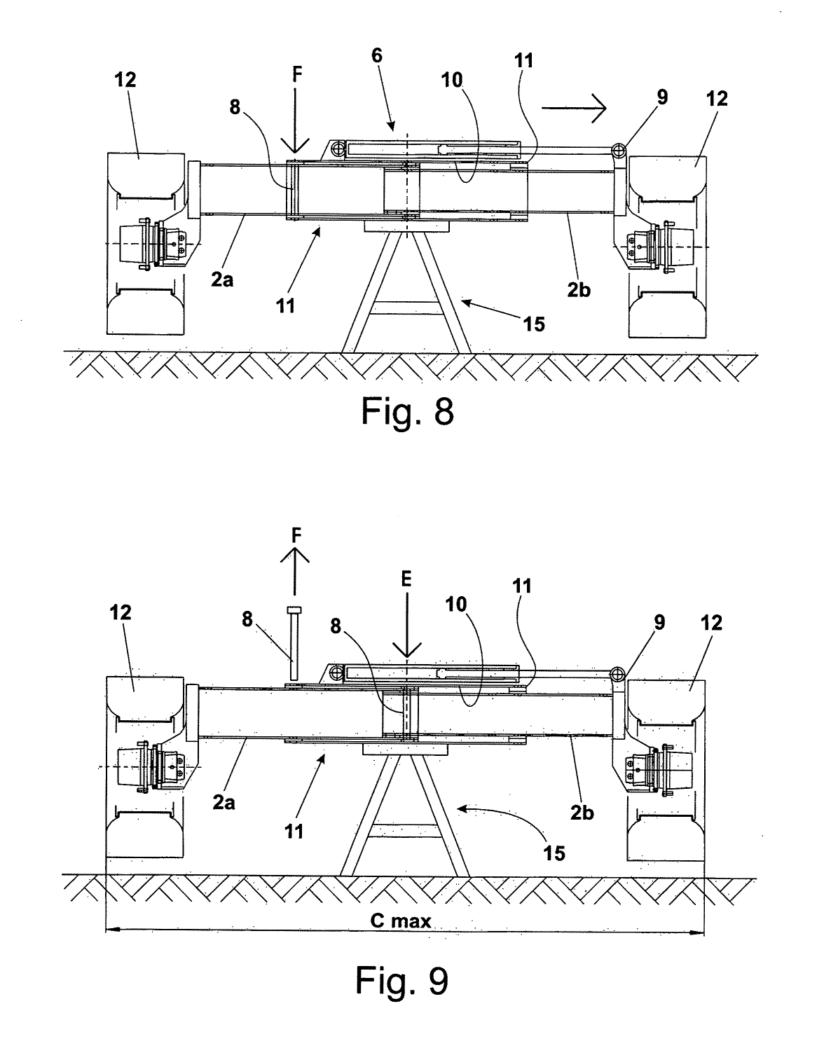

When the desired position of maximum relative extension (for example 0.5 m) is reached, the gudgeon 8, is placed to act as stop between the body 11 and the half-axle 2a. When this locking configuration has been reached, FIG. 8 shows the actuator 6 being operated to extend, until the maximum extension of the half-axle 2b with respect to the body 11 is reached.

When the extension is completed, FIG. 9 shows the extraction or removal of the stop or gudgeon 8 from position F and the introduction of a stop or gudgeon 8 in position E, which puts into effect the relative locking of the two half-axles.

In this latter configuration, the axle 2 is in its maximum extension (for example, all in all longer than 1 m with respect to the configuration of FIG. 4). The stability of keeping the reached configuration depends on the actuator or hydraulic cylinder 6, whose operation allows motion of the body 11 and thus the machine chassis 1, with respect to the axle 2, even after removal of the support 15, thus obtaining a reciprocal lateral movement. Once the support 15 has been removed, the wheels 12 rest on the ground and the machine can be positioned to perform the operation for which it is designed.

The resting base is considerably increased with respect to the on-road travelling configuration of FIG. 4. Moreover, the possibility of movements upon commands of the longitudinal axis of the chassis 1 with respect to the axle 2 allows lateral movements of the tool or aerial work platform 5, maintaining its height position and namely without the necessity to reposition the whole operating machine. Using the possibility of axial sliding between the half-axles 2a and 2b and between them and the seat 10 of the body 11, combining suitably the use of the first and second removable stops or gudgeons 7 and 8 and with the action of the actuator or hydraulic cylinder 6, it is possible to carry out relative lateral movements and consequent position changes between the chassis 1, and therefore its longitudinal axis, and the axle 2.

This type of lateral movement, which is particularly useful, for example, for harvesting certain fruits from relative trees (like dates) is optimized when the slide stroke of the stem of the actuator or hydraulic cylinder 6 is equal to the sum of the maximum extensions allowed for the two half-axles 2a and 2b. For example, if the extensions of the two half-axles 2a and 2b are each of 0.5 m, with a slide stroke of the stem of the actuator 6 of 1 m, the maximum of angular movement of the longitudinal axis of the chassis 1 is obtained, and consequently, the maximum width of the relative lateral movement.

1. A self-moving operating machine with variable axle width, including a chassis (1) to which a first axle (2) and a second axle (3) are constrained rispettivamente and by which an operating arm (4) is supported, which is hinged with its base to the chassis (1) and carries a tool (5) at its free end; said first axle (2) and second axle (3) being parallel to each other and provided with a pair of wheels (12) and with a pair of wheels (13) respectively; characterized in that at least said first axle (2) has variable width upon commands and includes at least two half-axles (2a, 2b) which are co-aligned and coupled to each other in axially sliding way; at least one of said half-axle (2a, 2b) being coupled in axially sliding way into a seat (10) made in a body (11) integral with the chassis (1) along a direction parallel to that of relative axial sliding between the two half-axles (2a, 2b); an actuator (6) being provided which is designed to act, upon command, between said body (11) and that of said two half-axles (2a, 2b) which is not coupled to the seat (10), in a direction parallel to that of relative axial sliding between the two half-axles (2a, 2b); first and second removable stops (7, 8) being capable of locking said two half-axle (2a, 2b) in pre-selected positions with respect to each other and with respect to at least one of them and said body (11), so as to allow lateral relative movements and subsequent positioning between the chassis 1, and then its longitudinal axis, and the axle 2.

2. A machine according to claim 1, characterized in that said half-axles (2a, 2b) have tubular shape, have the same length and are so proportioned that the half-axle (2b) which is not coupled to the seat (10) can be coupled inside the half-axle (2a) which is coupled in axial sliding way in the seat (10).

3. A machine according to claim 2, characterized in that said actuator (6) is a linear actuator and has the bottom side bound to said body (11) and the end of the stem bound to a connection point (9) fixed to the half-axle (2b) which is not coupled in the seat (10).

4. A machine according to claim 3, characterized in that said actuator (6) is bound and situated outside said body (11).

5. A machine according to claim 3, characterized in that said first stops (7) are shaped like pins and are proportionated so as to be housed in holes or recesses made in said body (11) and said half-axles (2a) and (2b) and to interact, once placed in position, between said body (11) and said half-axles (2a) and (2b).

6. A machine according to claim 5, characterized in that said second stop 8 include pins which are proportioned so as to be housed in holes or recesses provided in the half-axles 2a and 2b and to act between them.

7. A machine according to claim 5, characterized in that said half-axles (2a, 2b) have a tubular shape and polygonal cross section.

8. A machine according to claim 5, characterized in that said holes or recesses have their axes crosswise to the axes of said body (11), the relative seat (10) and said half-axles (2a) and (2b).

9. A machine according to claim 6, characterized in that said tool (5) is a people holding work platform.
